(19) United States
(12) Patent Application Publication
(10) Pub. No.: US 2020/0199386 A1
(43) Pub. Date: Jun. 25, 2020

(54) Radiation-Curable Ink Jet Ink Set, Ink Jet Recording Method, And Recorded Article

(71) Applicant: Seiko Epson Corporation, Tokyo (JP)

(72) Inventors: Toshiyuki YODA, Matsumoto (JP); Keitaro NAKANO, Matsumoto (JP); Toru SAITO, Yamagata (JP)

(21) Appl. No.: 16/724,503

(22) Filed: Dec. 23, 2019

(30) Foreign Application Priority Data
Dec. 25, 2018 (JP) 2018-240837

(51) Int. Cl. C09D 11/322; C09D 11/40; C08L 33/06; C08K 5/5397

(52) U.S. Cl. CPC C09D 11/322; C08K 5/5397; C08L 33/066; C09D 11/40

(57) ABSTRACT

A radiation-curable ink jet ink set according to the present disclosure includes: a radiation-curable clear ink composition; and a radiation-curable color ink composition, where: the clear ink composition contains a hydrogen abstraction-type photoinitiator and a hydroxy group-containing monomer; and the color ink composition contains an intramolecular cleavage-type photoinitiator and a colorant.

The present application is based on, and claims priority from, JP Application Serial Number 2018-240837, filed Dec. 25, 2018, the disclosure of which is hereby incorporated by reference herein in its entirety.

### BACKGROUND

### 1. Technical Field

The present disclosure relates to a radiation-curable ink jet ink set, an ink jet recording method, and a recorded article.

### 2. Related Art

An ink jet method of forming images or patterns on recording media by using radiation-curable inks that cure upon irradiation has been employed increasingly. Such radiation-curable inks have preferable characteristics as recording inks of slow curing until irradiation and rapid curing upon irradiation. In addition, there is also an advantage of a low environmental load since such radiation-curable inks are free of solvent that is not involved in reactions and are thus less likely to generate volatile solvent during curing.

To obtain high-quality images in an ink jet recording method using radiation-curable inks, there is an ink set designed such that an ink earlier in the printing order, among inks that constitute an ink set, has a faster curing rate and a larger total amount of an initiator and a sensitizer (see, for example, JP-A-2013-224364).

There is a need for a radiation-curable ink jet ink set having further low odor and excellent curing ability.

### SUMMARY

[1] A radiation-curable ink jet ink set including a radiation-curable clear ink composition and a radiation-curable color ink composition, where: the clear ink composition contains a hydrogen abstraction-type photoinitiator and a hydroxy group-containing monomer; and the color ink composition contains an intramolecular cleavage-type photoinitiator and a colorant.

[2] The radiation-curable ink jet ink set according to [1], where the hydrogen abstraction-type photoinitiator is a benzophenone-type photoinitiator or a thioxanthone-type photoinitiator.

[3] The radiation-curable ink jet ink set according to [1] or [2], where the hydroxy group-containing monomer is 4-hydroxybutyl acrylate or 2-hydroxy-3-phenoxypropyl acrylate.

[4] The radiation-curable ink jet ink set according to [1] to [3], where the intramolecular cleavage-type photoinitiator is an acylphosphine oxide photoinitiator.

[5] An ink jet recording method including: a color ink attaching step of attaching a radiation-curable color ink composition containing an intramolecular cleavage-type photoinitiator and a colorant to a recording medium by discharging the color ink composition from an ink jet head; a color ink curing step of curing the color ink composition; a clear ink attaching step of attaching a radiation-curable clear ink composition containing a hydrogen abstraction-type photoinitiator and a hydroxy group-containing monomer to the recording medium so as to partially or entirely overlap a region where the color ink composition is attached to; and a clear ink curing step of curing the clear ink composition.

[6] A recorded article that is recorded by the ink jet recording method according to [5], where an odor index is less than 10 calculated for the recorded article after the clear ink curing step by a three sample-comparison odor bag method.

### DESCRIPTION OF EXEMPLARY EMBODIMENTS

Hereinafter, several embodiments of the present disclosure will be described. The following embodiments will be described as examples of the present disclosure. Accordingly, the present disclosure is by no means limited to the following embodiments and encompasses various modifications that are carried out without changing the gist of the present disclosure. It is noted that all the constitution described hereinafter is not necessarily the essential constitution of the present disclosure.

The radiation-curable ink jet ink set according to an embodiment of the present disclosure is characterized by including a radiation-curable clear ink composition and a radiation-curable color ink composition, where: the clear ink composition contains a hydrogen abstraction-type photoinitiator and a hydroxy group-containing monomer; and the color ink composition contains an intramolecular cleavage-type photoinitiator and a colorant.

Moreover, the ink jet recording method according to an embodiment of the present disclosure is characterized by including: a color ink attaching step of attaching a radiation-curable color ink composition containing an intramolecular cleavage-type photoinitiator and a colorant to a recording medium by discharging the color ink composition from an ink jet head; a color ink curing step of curing the color ink composition; a clear ink attaching step of attaching a radiation-curable clear ink composition containing a hydrogen abstraction-type photoinitiator and a hydroxy group-containing monomer to the recording medium so as to partially or entirely overlap a region where the color ink composition is attached to; and a clear ink curing step of curing the clear ink composition.

Further, the recorded article according to an embodiment of the present disclosure is a recorded article that is recorded by the ink jet recording method according the embodiment of the present disclosure characterized in that an odor index is less than 10 calculated for the recorded article after the clear ink curing step by a three sample-comparison odor bag method.

Hereinafter, the radiation-curable ink jet ink set, the ink jet recording method, and the recorded article according to the present embodiments will be described.

### 1. Radiation-Curable Ink Jet Ink Set

The radiation-curable ink jet ink set (hereinafter, also simply referred to as “ink set”) according to an embodiment of the present disclosure includes a radiation-curable clear ink composition and a radiation-curable color ink composition, where: the clear ink composition contains a hydrogen abstraction-type photoinitiator and a hydroxy group-containing monomer; and the color ink composition contains an intramolecular cleavage-type photoinitiator and a colorant.

Herein, an embodiment of “radiation-curable” is also referred to as “UV-curable” or “photocurable” in some cases. In the present embodiment, a composition may be any radiation-curable composition to be used through curing under irradiation, and “UV-curable” and “UV-curable composition” may be read as “radiation-curable” and “radiation-curable composition”, respectively. Examples of such radiation include ultraviolet, infrared, visible light, and X-rays. The radiation is preferably ultraviolet since radiation sources as well as materials suitable for curing by UV irradiation are readily available and widely used.

In the present embodiment, a “radiation-curable ink jet ink composition” refers to an ink jet ink composition used for an ink jet recording method that includes a curing step of obtaining a cured film by actinic irradiation of a radiation-curable ink jet ink composition attached to a recording medium. For this purpose, publicly known ink jet ink compositions may be used.

Hereinafter, components that are contained or may be contained in the clear ink composition (hereinafter, also simply referred to as “clear ink”) and the color ink composition (hereinafter, also referred to as “color ink”) that constitute the radiation-curable ink jet ink set according to an embodiment of the present disclosure will be described.

### 1.1. Clear Ink Composition

In the present embodiment, the clear ink composition contains a hydrogen abstraction-type photoinitiator and a hydroxy group-containing monomer. In the present embodiment, the clear ink composition refers to an ink composition substantially free of colorant, but not an ink used for coloration of recording media. Specifically, the clear ink composition is free of colorant, but when a colorant is contained, the content is 0.1% by mass or less and more preferably 0.05% by mass or less. Here, examples of the colorant include those described hereinafter for the color ink composition. In the present embodiment, the clear ink composition is used for, but is not limited to, improving characteristics, such as scratch resistance, adjusting gloss of recording media, enhancing fixability and coloring properties of color inks, and so forth, in addition to reducing odor from recorded articles.

### 1.1.1. Hydrogen Abstraction-Type Photoinitiators

In the present embodiment, the clear ink composition contains a hydrogen abstraction-type photoinitiator. The hydrogen abstraction-type photoinitiator causes to form, upon irradiation, a copolymer of a hydroxy group-containing monomer, which is a polymerizable compound, thereby curing the clear ink. In the present embodiment, since the clear ink contains a hydrogen abstraction-type photoinitiator, the clear ink per se has low odor. By incorporating a hydrogen abstraction-type photoinitiator, the clear ink has inferior curing ability compared with an ink containing an intramolecular cleavage-type photoinitiator. However, this poses little problem since the clear ink does not contain any colorant in the film.

As in the foregoing, the present embodiment can reduce odor from a recorded article by covering the recorded article obtained from the color ink composition described hereinafter with the clear ink, thereby achieving a radiation-curable ink jet ink set having low odor and excellent curing ability.

The hydrogen abstraction-type photoinitiator is not particularly limited provided that the polymerization of a hydroxy group-containing monomer is started upon irradiation, and examples include benzophenone-type photoinitiators, thioxanthone-type photoinitiators, benzil-type photoinitiators, and Michler's ketone-type photoinitiators. Among these photoinitiators, benzophenone-type photoinitiators or thioxanthone-type photoinitiators are preferable.

Examples of the benzophenone-type photoinitiators include benzophenone, 4-chlorobenzophenone, 4,4′-phenylbenzophenone, and 4-benzoyl 4′-methyldiphenyl sulfide. The above-mentioned benzophenone and derivatives thereof can increase a curing rate by using tertiary amines as hydrogen donors.

Exemplary commercial products of the benzophenone-type photoinitiators include SpeedCure MBP (4-methylbenzophenone), SpeedCure MBB (methyl 2-benzoylbenzoate), SpeedCure BMS (4-benzoyl 4′-methyldiphenyl sulfide), SpeedCure PBZ (4-phenylbenzophenone), and SpeedCure EMK (4,4′-bis(diethylamino)benzophenone) (all trade names from DKSH Japan).

Examples of the thioxanthone-type photoinitiators include thioxanthone, diethylthioxanthone, isopropylthioxanthone, and chlorothioxanthone. Preferably, diethylthioxanthone is 2,4-diethylthioxanthone, isopropylthioxanthone is 2-isopropylthioxanthone, and chlorothioxanthone is 2-chlorothioxanthone. A composition containing such a thioxanthone-type photoinitiator exhibits further excellent curing properties, storage stability, and discharge stability. Among these photoinitiators, thioxanthone-type photoinitiators including diethylthioxanthone are further preferable. By including diethylthioxanthone, wide-range UV radiation can efficiently convert photoinitiators into active species.

Exemplary commercial products of the thioxanthone-type photoinitiators include SpeedCure DETX (2,4-diethylthioxanthone), SpeedCure ITX (2-isopropylthioxanthone), SpeedCure CTX (2-chlorothioxanthone), SpeedCure CPTX (1-chloro-4-propoxythioxanthone) (all trade names from DKSH Japan), and KAYACURE DETX (2,4-diethylthioxanthone) (trade name from Nippon Kayaku Co., Ltd.).

The content of the hydrogen abstraction-type photoinitiator is preferably 0.5% by mass or more and 8.0% by mass or less and more preferably 1.0% by mass or more and 7.0% by mass or less relative to the total mass of the clear ink. When the content of the hydrogen abstraction-type photoinitiator falls within the above ranges, it is possible to ensure curing properties of the clear ink.

### 1.1.2. Hydroxy Group-Containing Monomers

In the present embodiment, the clear ink composition contains a hydroxy group-containing monomer. The hydroxy group-containing monomer starts polymerization upon irradiation in the presence of the above-described hydrogen abstraction-type photoinitiator, thereby forming a copolymer. As a result, the clear ink is cured. In the present embodiment, curing properties of a recorded article are ensured by incorporating, into the clear ink, a hydroxy group-containing monomer that can impart excellent hardness to the coating film. Moreover, by covering a recorded article obtained from the color ink composition described hereinafter with the clear ink, odor from the recorded article can be reduced.

Both hydroxy group-containing monofunctional monomers and polyfunctional monomers may be used as the hydroxy group-containing monomer. Among these monomers, 4-hydroxybutyl acrylate or 2-hydroxy-3-phenoxypropyl acrylate is preferably used. Since not only are curing properties of ink improved, but also the amount of a photoinitiator that could potentially cause coloration of the clear ink can be reduced, 4-hydroxybutyl acrylate is preferably used.

The content of the hydroxy group-containing monomer is preferably 3% by mass or more and 50% by mass or less, more preferably 5% by mass or more and 40% by mass or less, and further preferably 7% by mass or more and 30% by mass or less relative to the total mass of the clear ink. By including the hydroxy group-containing monomer within the above-mentioned ranges, excellent coating hardness is achieved. Moreover, by covering a recorded article obtained from the color ink composition with the clear ink, odor from the recorded article can be reduced.

### 1.1.3. Other Polymerizable Compounds (Monomers)

In the present embodiment, the clear ink composition may contain polymerizable compounds other than the hydroxy group-containing monomer. Polymerizable compounds can polymerize upon irradiation on their own or by the action of photoinitiators, thereby curing ink on recording media. Such polymerizable compounds are not particularly limited, and conventionally known monofunctional, difunctional, and trifunctional or higher polyfunctional monomers as well as oligomers may be specifically used. Such polymerizable compounds may be used alone or in combination.

Here, such polymerizable compounds include a radical polymerizable compound from a viewpoint of further enhancing curing properties of a composition as well as achieving high versatility and high simplicity. Alternatively or in addition, the polymerizable compounds preferably include a polymerizable compound having a vinyl ether group and a (meth)acrylate group from a viewpoint of enhancing curing properties, further lowering the viscosity of the composition, and enhancing solubility of photoinitiators if used. The polymerizable compound having a vinyl ether group and a (meth)acrylate group is preferably a radical polymerizable compound having a vinyl ether group and a (meth)acrylate group. Examples of such a polymerizable compound include monofunctional or polyfunctional (meth)acrylates having a vinyl ether group, and these (meth)acrylates are preferable from the same viewpoint as above.

The (meth)acrylates having a vinyl ether group are not particularly limited, but preferably include a compound represented by the following general formula (1) in view of high flash point and capability of further lowering the viscosity of the composition and further enhancing curing properties of the composition.

CH₂═CR¹—COOR²—O—CH═CH—R³ (1)

where: R¹ is a hydrogen atom or a methyl group; R² is a divalent organic residue having 2 to 20 carbon atoms; and R³ is a hydrogen atom or a monovalent organic residue having 1 to 11 carbon atoms.

Hereinafter, the (meth)acrylate having a vinyl ether group represented by general formula (1) is simply referred to as “compound of formula (1)” in some cases.

By incorporating the compound of formula (1) into the composition according to the present embodiment, excellent curing properties of the composition can be achieved. Moreover, by including the compound of formula (1), the viscosity of the composition is readily lowered. Further, a compound having both a vinyl ether group and a (meth)acrylic group within a molecule is preferably used to improve curing properties of the composition, compared with the separate use of a compound having a vinyl ether group and a compound having a (meth)acrylic group.

In the above general formula (1), the divalent organic residue having 2 to 20 carbon atoms, which is represented by R², is suitably a linear, branched, or cyclic optionally substituted alkylene group having 2 to 20 carbon atoms; an optionally substituted alkylene group having 2 to carbon atoms and an oxygen atom of an ether linkage and/or ester linkage within the structure; and an optionally substituted divalent aromatic group having 6 to 11 carbon atoms. Among these groups, an alkylene group having 2 to 6 carbon atoms, such as an ethylene group, an n-propylene group, an isopropylene group, or a butylene group; and a alkylene group having 2 to 9 carbon atoms and an oxygen atom of an ether linkage within the structure, such as an oxyethylene group, an oxy-n-propylene group, an oxyisopropylene group, and an oxybutylene group, are suitably used. Further, a compound having a glycol ether chain in which R² is an alkylene group having 2 to 9 carbon atoms and an oxygen atom of an ether linkage within the structure, such as an oxyethylene group, an oxy-n-propylene group, an oxyisopropylene group, and an oxybutylene group, is more preferable from a viewpoint of further lowering the viscosity and improving curing properties of the radiation-curable ink jet composition.

In the above general formula (1), the monovalent organic residue having 1 to 11 carbon atoms, which is represented by R³, is suitably a linear, branched, or cyclic optionally substituted alkyl group having 1 to 10 carbon atoms or an optionally substituted aromatic group having 6 to 11 carbon atoms. Among these groups, an alkyl group having 1 or 2 carbon atoms, such as a methyl group or an ethyl group; and an aromatic group having 6 to 8 carbon atoms, such as a phenyl group or a benzyl group, are suitably used.

When each of the above above-described organic residues is an optionally substituted group, the substituent is classified into a carbon atom-containing group and a carbon atom-free group. When such a substituent is a carbon atom-containing group, the carbon atom(s) is counted for the carbon number of the organic residue. Examples of the carbon atom-containing group include, but are not limited to, a carboxy group and an alkoxy group. Meanwhile, examples of the carbon atom-free group include, but are not limited to, a hydroxy group and a halo group.

The content of the compound of formula (1) is preferably 1% by mass or more and 50% by mass or less, more preferably 5% by mass or more and 40% by mass or less, and further preferably 10% by mass or more and 30% by mass or less relative to the total mass of the clear ink. When the content of the compound of formula (1) falls within the above-mentioned ranges, it is possible to lower the viscosity of the clear ink, achieve further excellent curing properties of the composition, and maintain storage properties of ink in an excellent state.

Specific examples of the compound of formula (1) include, but are not particularly limited to, 2-(vinyloxy)ethyl (meth)acrylate, 3-(vinyloxy)propyl (meth)acrylate, 1-methyl-2-(vinyloxy)ethyl (meth)acrylate, 2-(vinyloxy)propyl (meth)acrylate, 4-(vinyloxy)butyl (meth)acrylate, 1-methyl-3-(vinyloxy)propyl (meth)acrylate, 1-(vinyloxymethyl)propyl (meth)acrylate, 2-methyl-3-(vinyloxy)propyl (meth)acrylate, 1,1-dimethyl-2-(vinyloxy)ethyl (meth)acrylate, 3-(vinyloxy)butyl (meth)acrylate, 1-methyl-2-(vinyloxy)propyl (meth)acrylate, 2-(vinyloxy)butyl (meth)acrylate, 4-(vinyloxy)cyclohexyl (meth)acrylate, 6-(vinyloxy)hexyl (meth)acrylate, [4-(vinyloxymethyl)cyclohexyl]methyl (meth)acrylate, [3-(vinyloxymethyl)cyclohexyl]methyl (meth)acrylate, [2-(vinyloxymethyl)cyclohexyl]methyl (meth)acrylate, [p-(vinyloxymethyl)phenyl]methyl (meth)acrylate, [m-(vinyloxymethyl)phenyl]methyl (meth)acrylate, [o-(vinyloxymethyl)phenyl]methyl (meth)acrylate, 2-[2-(vinyloxy) ethoxy]ethyl methacrylate, 2-[2-(vinyloxy)ethoxy]ethyl acrylate (VEEA), 2-(vinyloxyisopropoxy)ethyl (meth)acrylate, 2-(vinyloxyethoxy) propyl (meth)acrylate, 2-(vinyloxyethoxy) isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy) propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy) isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenyloxyethoxy)ethyl (meth)acrylate, 2-(isopropenyloxyethoxyethoxy)ethyl (meth)acrylate, 2-(isopropenyloxyethoxyethoxyethoxy)ethyl (meth)acrylate, 2-(isopropenyloxyethoxyethoxyethoxyethoxy)ethyl (meth)acrylate, polyethylene glycol monovinyl ether (meth)acrylate, and polypropylene glycol monovinyl ether (meth)acrylate.

Among these compounds, 2-(vinyloxyethoxy)ethyl (meth)acrylate, in other words, at least either of 2-(vinyloxyethoxy)ethyl acrylate and 2-(vinyloxyethoxy)ethyl methacrylate is preferable due to the capability of further lowering the viscosity of ink, high flash point, and excellent curing properties of ink, and 2-(vinyloxyethoxy)ethyl acrylate is more preferable. Due to simple structure and small molecular weight, both 2-(vinyloxyethoxy)ethyl acrylate and 2-(vinyloxyethoxy)ethyl methacrylate can remarkably lower the viscosity of the radiation-curable ink jet ink composition. Here, 2-(vinyloxyethoxy)ethyl methacrylate is 2-[2-(vinyloxy)ethoxy]ethyl methacrylate or 2-[1-(vinyloxy)ethoxy]ethyl methacrylate, and 2-(vinyloxyethoxy)ethyl acrylate is 2-[2-(vinyloxy)ethoxy]ethyl acrylate or 2-[1-(vinyloxy)ethoxy]ethyl acrylate. Compared with 2-(vinyloxyethoxy)ethyl methacrylate, 2-(vinyloxyethoxy)ethyl acrylate is excellent in terms of curing properties.

The content of the above-described (meth)acrylate esters having a vinyl ether group, especially 2-(vinyloxyethoxy)ethyl (meth)acrylate, is preferably 10% by mass or more and 70% by mass or less and more preferably 20% by mass or more and 50% by mass or less relative to the total mass of the clear ink. The content of 10% by mass or more results in lower viscosity of the clear ink and further excellent curing properties of the clear ink. Meanwhile, the content of 70% by mass or less results in further excellent storage properties of the clear ink and excellent surface gloss of recorded articles.

In the present embodiment, the clear ink may contain one or two or more monofunctional, difunctional, trifunctional, and higher polyfunctional monomers other than those illustrated above. Examples of such monomers include, but are not particularly limited to, unsaturated carboxylic acids, such as (meth)acrylic acid, itaconic acid, crotonic acid, isocrotonic acid, and maleic acid; salts of these unsaturated carboxylic acids; esters, urethanes, amides, and anhydrides of these unsaturated carboxylic acids; acrylonitrile; styrene; various unsaturated polyesters; unsaturated polyethers; unsaturated polyamides; and unsaturated urethanes.

As other monofunctional monomers or polyfunctional monomers, N-vinyl compounds may be contained. Examples of N-vinyl compounds include, but are not particularly limited to, N-vinylformamide, N-vinylcarbazole, N-vinylacetamide, N-vinylpyrrolidone, N-vinylcaprolactam, acryloylmorpholine, and derivatives thereof.

The clear ink may contain monofunctional (meth)acrylates as monofunctional monomers. In this case, it is possible to readily achieve low viscosity of the composition, excellent solubility of photoinitiators and other additives, and discharge stability during ink jet recording. Examples of the monofunctional (meth)acrylates include, but are not particularly limited to, isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, diethylene glycol 2-ethylhexyl ether (meth)acrylate, 2-hydroxybutyl (meth)acrylate, butoxyethyl (meth)acrylate, diethylene glycol ethyl ether (meth)acrylate, diethylene glycol methyl ether (meth)acrylate, polyethylene glycol methyl ether (meth)acrylate, propylene glycol methyl ether (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, lactone-modified flexible (meth)acrylates, tert-butylcyclohexyl (meth)acrylate, dicyclopentanyl (meth)acrylate, dicyclopentenyloxyethyl (meth)acrylate, 2-(isopropenyloxyethoxy)ethyl (meth)acrylate, 2-(isopropenyloxyethoxyethoxy)ethyl (meth)acrylate, 2-(isopropenyloxyethoxyethoxyethoxy)ethyl (meth)acrylate, 2-(isopropenyloxyethoxyethoxyethoxyethoxy)ethyl (meth)acrylate, polyethylene glycol monovinyl ether (meth)acrylate, and polypropylene glycol monovinyl ether (meth)acrylate. Among these (meth)acrylates, phenoxyethyl (meth)acrylate is preferable.

The content of the monofunctional monomers is preferably 10% by mass or more and 60% by mass or less and more preferably 20% by mass or more and 50% by mass or less relative to the total mass of the composition. When the content falls within the above-mentioned preferable ranges, curing properties, initiator solubility, storage stability, and discharge stability tend to become further excellent.

The clear ink may contain polyfunctional (meth)acrylates as polyfunctional monomers. Among polyfunctional (meth)acrylates, examples of difunctional (meth)acrylates include, but are not particularly limited to, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, tricyclodecanedimethanol di(meth)acrylate, bisphenol A-EO (ethylene oxide) adduct di(meth)acrylate, bisphenol A-PO (propylene oxide) adduct di(meth)acrylate, hydroxypivalic acid neopentyl glycol ester di(meth)acrylate, polytetramethylene glycol di(meth)acrylate, diethylene glycol di(meth)acrylate, and triethylene glycol di(meth)acrylate.

Further, examples of tri- and higher-functional (meth)acrylates include trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, propoxylated glycerol tri(meth)acrylate, caprolactone-modified trimethylolpropane tri(meth)acrylate, ethoxylated pentaerythritol tetra(meth)acrylate, and caprolactam-modified dipentaerythritol hexa(meth)acrylate.

Among these polyfunctional (meth)acrylates, dipropylene glycol di(meth)acrylate, tripropylene glycol di(meth)acrylate, diethylene glycol di(meth)acrylate, triethylene glycol di(meth)acrylate, and pentaerythritol tri(meth)acrylate are preferable, and dipropylene glycol di(meth)acrylate and pentaerythritol tri(meth)acrylate are more preferable.

The content of the polyfunctional monomers is preferably 60% by mass or less, more preferably 50% by mass or less, and further preferably 40% by mass or less relative to the total mass of the clear ink.

Since toughness, heat resistance, and chemical resistance of a cured film are enhanced, a combined use of a monofunctional (meth)acrylate and a difunctional (meth)acrylate is also preferable, and a combined use of phenoxyethyl (meth)acrylate and dipropylene glycol di(meth)acrylate is further preferable.

In the clear ink, the content of di- and higher-functional acrylate compounds [polyfunctional (meth)acrylates] is preferably 15% by mass or less, more preferably 10% by mass or less, and further preferably 5% by mass or less relative to the total mass of the ink composition. Still further preferably, such acrylate compounds are not contained. When the content of di- and higher-functional acrylate compounds in the clear ink falls within the above-mentioned ranges, it is possible to lower the viscosity of ink further suitably, thereby achieving good discharge stability. In addition, weatherability of the coating film is improved. Moreover, the ink coating film is flexible after curing and thus applicable to stretching and the like during post processing.

Further, to enhance adhesion and toughness of a cured film, monofunctional oligomers or difunctional or higher polyfunctional oligomers may be contained in addition to the above-described monomers. The types of the oligomers are not particularly limited, and examples include various oligomers, such as acrylic oligomers formed from acrylic monomers; styrene-acrylic oligomers formed from styrene and acrylic monomers; aliphatic, alicyclic, aromatic, or other urethane acrylate oligomers; epoxy acrylate oligomers; and polyester acrylate oligomers. Herein, these oligomers are collectively referred to as acrylate oligomers. The content of the acrylate oligomers is preferably 3% by mass or more and less than 30% by mass and more preferably 5% by mass or more and less than 25% by mass. When the content is the lower limit or more, a cured film exhibits good adhesion and toughness. Meanwhile, when the content is the upper limit or less, good dischargeability is achieved due to suitably low viscosity of ink.

The content of polymerizable compounds is preferably 35% by mass of more and 95% by mass or less and more preferably 45% by mass or more and 90% by mass or less relative to the total mass of the composition. When the content of polymerizable compounds falls within the above-mentioned ranges, it is possible to reduce viscosity and odor as well as achieve excellent solubility and reactivity of photoinitiators and excellent surface gloss of printed articles.

### 1.1.4. Other Additives

In the present embodiment, to achieve further excellent scratch resistance, the clear ink may contain a surfactant as a slip agent. The slip agent is not particularly limited, and a polyester-modified silicone and a polyether-modified silicone, for example, may be used as a silicone surfactant. Particularly preferably, polyether-modified polydimethylsiloxane or polyester-modified polydimethylsiloxane is used. Specific examples include BYK-347, BYK-348, BYK-UV 3500, 3510, 3530, and 3570 (trade names from BYK Japan KK). In addition, examples of polyacrylate surfactants include BYK 350, BYK 352, BYK 354, and BYK 355 (trade names from BYK Japan KK).

In the present embodiment, the clear ink may further contain a polymerization inhibitor. By incorporating a polymerization inhibitor into the clear ink, storage stability of the clear ink is enhanced. Such a polymerization inhibitor is not particularly limited, and examples include one or more selected from the group consisting of phenolic compounds, hydroquinone derivatives, and quinone compounds. Specific examples of the polymerization inhibitor include hydroquinone, p-methoxyphenol, cresol, tert-butylcatechol, 3,5-di-tert-butyl-4-hydroxytoluene, 2,2′-methylenebis(4-methyl-6-tert-butylphenol), 2,2′-methylenebis(4-ethyl-6-butylphenol), and 4,4′-thiobis(3-methyl-6-tert-butylphenol). Exemplary commercial products of the polymerization inhibitor include Irgastab UV 10 and UV 22 (trade names from BASF Japan Ltd.).

In the present embodiment, the clear ink may further contain other additives. Examples of such additives include conventionally known polymerization accelerators, such as sensitizing dyes; penetration enhancers; fixing agents; antimicrobial agents; preservatives; antioxidants; UV absorbers; chelating agents; pH adjusters; and thickeners.

### 1.2. Color Ink Composition

In the present embodiment, the color ink composition contains an intramolecular cleavage-type photoinitiator and a colorant. In the present embodiment, recording is performed by using the color ink composition containing a relatively odorous intramolecular cleavage-type photoinitiator. Subsequently, the obtained recorded article is covered with the clear ink to reduce odor from an image formed by the color ink composition, thereby reducing odor from the recorded article.

### 1.2.1. Intramolecular Cleavage-Type Photoinitiators

In the present embodiment, the color ink composition contains an intramolecular cleavage-type photoinitiator. By incorporating an intramolecular cleavage-type photoinitiator into the color ink composition, the color ink does not experience insufficient curing. In addition, since decomposition products of the intramolecular cleavage-type photoinitiator are blocked by a cured film of the clear ink, the odor problem does not arise.

Exemplary intramolecular cleavage-type photoinitiators include benzil ketal photoinitiators, alkylphenone photoinitiators, aminoalkylphenone photoinitiators, phosphine oxide photoinitiators, titanocene photoinitiators, and oxime photoinitiators. More specifically, exemplary benzil ketal photoinitiators include 2,2-dimethoxy-1,2-diphenylethan-1-one. Exemplary alkylphenone photoinitiators include 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, 2-hydroxy-1-[4-[4-(2-hydroxy-2-methylpropionyl)benzyl]phenyl]-2-methylpropan-1-one, acetophenone, and 2-phenyl-2-(p-toluenesulfonyloxy)acetophenone. Exemplary aminoalkylphenone photoinitiators include p-dimethylaminoacetophenone, p-dimethylaminopropiophenone, 2-methyl-1-(4-methylthiophenyl)-2-morpholinopropan-1-one, 2-benzyl-2-(dimethylamino)-1-(4-morpholinophenyl)butanone-1, and 2-(dimethylamino)-2-[(4-methylphenyl)methyl]-1-[4-(4-morpholinyl)phenyl]-1-butanone. Exemplary phosphine oxide photoinitiators include (2,4,6-trimethylbenzoyl)diphenylphosphine oxide and bis(2,4,6-trimethylbenzoyl)phenylphosphine oxide. Exemplary titanocene photoinitiators include bis(η5-2,4-cyclopentadien-1-yl)bis[2,6-difluoro-3-(1H-pyrrol-1-yl)phenyl]titanium. Exemplary oxime photoinitiators include 1-[4-(phenylthio)phenyl]-1,2-octanedione 2-(O-benzoyloxime) and 1-[9-ethyl-6-(2-methylbenzoyl)-9H-carbazol-3-yl]ethanone 1-(O-acetyloxime). The photoinitiators may be used alone or in combination.

Among these photoinitiators, acylphosphine oxide photoinitiators are preferably used as intramolecular cleavage-type photoinitiators.

Acylphosphine oxide photoinitiators are preferable because these photoinitiators are photocleavage-type photoinitiators that are intramolecularly cleaved upon light absorption. In other words, reduced absorption called photobleaching is observed in acylphosphine oxide photoinitiators since the chromophore structure changes considerably before and after photocleavage, thereby greatly changing absorption. In addition, despite absorption from the UV region to the visible region, acylphosphine oxide photoinitiators are less likely to cause yellowing of coating films and are excellent in internal curing. For these reasons, acylphosphine oxide photoinitiators are particularly preferable for transparent thick films or coating films containing pigment with high hiding power.

Among acylphosphine oxide photoinitiators, (2,4,6-trimethylbenzoyl)diphenylphosphine oxide and bis(2,4,6-trimethylbenzoy)phenylphosphine oxide are more preferable. In addition, these photoinitiators are also preferably used in combination. These photoinitiators are preferable because the absorption wavelength of these photoinitiators also exists on the longer wavelength side of 380 nm whereas the UV absorption region of UV absorbers is 380 nm or less as described hereinafter. Accordingly, it is possible to cause curing reactions to progress smoothly by irradiating with light having an emission peak wavelength on the longer wavelength side of 380 nm and having a wavelength which can be absorbed by these photoinitiators.

Due to excellent compatibility with the foregoing polymerizable compounds, 2,4,6-(trimethylbenzoyl)diphenylphosphine oxide is further preferable. Specific examples of 2,4,6-(trimethylbenzoyl)diphenylphosphine oxide include Darocur TPO (trade name from BASF Japan Ltd.).

Due to wide light absorption characteristics, bis(2,4,6-trimethylbenzoyl)phenylphosphine oxide is further preferable. Specific examples of bis(2,4,6-trimethylbenzoyl)phenylphosphine oxide include Irgacure 819 (trade name from BASF Japan Ltd.).

Here, acylphosphine oxide photoinitiators may be used in combination with other photoinitiators. By combining acylphosphine oxide photoinitiators and other photoinitiators, it is possible to maximize the respective characteristics.

To achieve good curing properties of ink and avoid residual initiators in dissolution as well as coloration resulting from initiators, the content of the intramolecular cleavage-type photoinitiators is preferably 1.0% by mass or more and 20.0% by mass or less, more preferably 3.0% by mass or more and 15.0% by mass or less, and further preferably 8.0% by mass or more and 15.0% by mass or less relative to the total mass of the color ink. When the content of the intramolecular cleavage-type photoinitiators falls within the above-mentioned ranges, it is possible to achieve excellent curing properties of ink as well as good solubility in ink.

### 1.2.2. Colorants

In the present embodiment, the color ink composition contains a colorant. At least either of pigments or dyes may be used for the colorant.

When pigments are used, weatherability of the color ink composition is enhanced. Both inorganic pigments and organic pigments may be used as pigments.

As inorganic pigments, carbon black (C.I. Pigment Black 7), such as furnace black, lamp black, acetylene black, or channel black; iron oxide; or titanium oxide may be used.

Exemplary organic pigments include azo pigments, such as insoluble azo pigments, condensed azo pigments, azo lake pigments, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates (basic dye chelates and acid dye chelates, for example); lake dyes (lake basic dyes, lake acid dyes); nitro pigments; nitroso pigments; aniline black; and daylight fluorescent pigments.

Exemplary black pigments include No. 2300, No. 900, MCF 88, No. 33, No. 40, No. 45, No. 52, MA 7, MA 8, MA 100, No. 2200B, and so forth (all trade names from Mitsubishi Chemical Corporation); Raven 5750, Raven 5250, Raven 5000, Raven 3500, Raven 1255, Raven 700, and so forth (all trade names from Columbian Carbon Company); Regal 400R, Regal 330R, Regal 660R, Mogul L, Monarch 700, Monarch 800, Monarch 880, Monarch 900, Monarch 1000, Monarch 1100, Monarch 1300, Monarch 1400, and so forth (all trade names from CABOT JAPAN K.K.); Color Black FW 1, Color Black FW 2, Color Black FW 2V, Color Black FW 18, Color Black FW 200, Color Black S 150, Color Black S 160, Color Black S 170, Printex 35, Printex U, Printex V, Printex 140U, Special Black 6, Special Black 5, Special Black 4A, Special Black 4, and so forth (all trade names from Degussa AG).

Exemplary white pigments include C.I. Pigment White 6, 18, and 21; metal oxides; and metal compounds, such as barium sulfate and calcium carbonate. Exemplary metal oxides include titanium dioxide, zinc oxide, silica, alumina, and magnesium oxide.

Exemplary yellow pigments include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Exemplary magenta pigments include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violet 19, 23, 32, 33, 36, 38, 43, and 50.

Exemplary cyan pigments include C.I. Pigment Blue 1, 2, 3, 15, 15:1, 15:2, 15:3, 15:34, 15:4, 16, 18, 22, 25, 60, 65, and 66; and C.I. Vat Blue 4 and 60.

Further, examples of color pigments other than magenta, cyan, and yellow include C.I. Pigment Green 7 and 10; C.I. Pigment Brown 3, 5, 25, and 26; and C.I. Pigment Orange 1, 2, 5, 7, 13, 14, 15, 16, 24, 34, 36, 38, 40, 43, and 63.

The above-described pigments may be used alone or in combination.

When the above-described pigments are used, the average particle size is preferably 300.0 nm or less and more preferably 50.0 nm to 200.0 nm. When the average particle size falls within the above-mentioned ranges, it is possible to achieve further excellent reliability in discharge stability, dispersion stability, and the like of ink as well as to form images with excellent quality. The average particle size of pigments herein is measured by a dynamic light scattering method.

In the present embodiment, when the color ink contains pigments, dispersants may be additionally included to achieve better pigment dispersibility. Exemplary dispersants include, but are not particularly limited to, dispersants commonly used for preparing pigment dispersions, such as polymer dispersants. Specific examples include dispersants that primarily contain one or more of propoxylated ethylenediamine, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. Exemplary commercial products of polymer dispersants include Discole series from DKS Co. Ltd., Solsperse series, such as Solsperse 36000, from Lubrizol Corporation, and Disperbyk series from BYK Japan KK.

In the present embodiment, when dyes are used as colorants, such dyes are not particularly limited, and acid dyes, direct dyes, reactive dyes, and basic dyes may be used. Exemplary dyes include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1 and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35.

The above-described colorants may be used alone or in combination. Moreover, pigments and dyes may be used in combination. Since excellent color reproducibility can be achieved, the content of colorants is preferably 0.5% by mass or more and 10% by mass or less relative to the total mass of the color ink.

### 1.2.3. Polymerizable Compounds (Monomers)

In the present embodiment, the color ink composition contains a polymerizable compound. For such polymerizable compounds, the same polymerizable compounds as the polymerizable compounds usable for the above-described clear ink composition may be used. Accordingly, the description thereof will be omitted here.

### 1.2.4. Other Additives

In the present embodiment, the color ink composition may contain other additives. For other additives, the same additives as other additives usable for the above-described clear ink composition may be used. Accordingly, the description thereof will be omitted here.

### 1.3. Physical Properties of Clear Ink Composition and Color Ink Composition

In the present embodiment, the viscosity at 20° C. of the radiation-curable clear ink composition and color ink composition is preferably 5 mPa·s or more and 50 mPa·s or less and more preferably 20 mPa·s or more and 40 mPa·s or less. When the viscosity at 20° C. of the clear ink composition and color ink composition falls within the above-mentioned ranges, an appropriate amount of ink is discharged from nozzles, thereby further suppressing curved flight and/or scattering of ink. Consequently, such ink can be suitably used for an ink jet apparatus. Here, the viscosity can be measured with a viscoelasticity tester MCR-300 (from Paar Physica) by increasing a shear rate from 10 to 1,000 in an environment of 20° C. and reading the viscosity at a shear rate of 200.

The radiation-curable clear ink composition and color ink composition have viscosities higher than aqueous ink compositions commonly used for ink jet applications and thus experience large viscosity changes due to temperature fluctuations during discharge. Such viscosity changes of the compositions could possibly greatly affect changes in droplet size and changes in droplet discharge speed, thereby causing deterioration in image quality. Accordingly, it is preferable to keep the temperature of ink as constant as possible during discharge.

In the present embodiment, the radiation-curable clear ink composition and color ink composition preferably have a surface tension at 20° C. of 20 mN/m or more and 30 mN/m or less. When the surface tension at 20° C. of ink falls within the above-mentioned range, the composition is less likely to wet nozzles that have underwent liquid-repellent treatment. Consequently, it is possible to discharge an appropriate amount of ink from the nozzles, thereby further suppressing curved flight and/or scattering of ink. Accordingly, such ink can be suitably used for an ink jet recording apparatus. Here, the surface tension can be measured with an automatic surface tensiometer CBVP-Z (from Kyowa Interface Science Co., Ltd.) by observing the surface tension when a platinum plate is wet with a composition in an environment of 20° C.

### 1.4. Ink Preparation Method

In the present embodiment, the radiation-curable clear ink composition and color ink composition can be prepared by mixing the respective ink components to be contained and stirring to mix the components satisfactorily uniformly. As the mixing method for the respective components, a method of successively adding materials to a vessel equipped with a stirrer, such as a mechanical stirrer or a magnetic stirrer, followed by stirring and mixing is employed. As a filtering method, centrifugal filtration, filter filtration, and the like can be employed.

### 1.5. Ink Jet Recording Method

Next, an ink jet recording method according to the present embodiment will be described.

The ink jet recording method according to the present embodiment is characterized by including: a color ink attaching step of attaching a color ink composition that constitutes the above-described radiation-curable ink jet ink set to a recording medium by discharging the color ink composition from an ink jet head; a color ink curing step of curing the color ink composition; a clear ink attaching step of attaching a clear ink composition that constitutes the radiation-curable ink jet ink set to the recording medium so as to partially or entirely overlap a region where the color ink composition is attached to; and a clear ink curing step of curing the clear ink composition. Cured films are thus formed on the recording medium in the region where the inks are applied to, thereby yielding a recorded article.

Here, the ink jet recording method according to the present embodiment is performed by using an ink jet recording apparatus, for example. The color ink curing step and the clear ink curing step encompass a first preliminary curing step of preliminarily curing a coating film of the color ink; a second preliminary curing step of preliminarily curing a coating film of the clear ink; and a full curing step of fully curing the first and the second coating films.

The term “preliminary curing” herein means temporary fixing of ink (pinning), more specifically, curing before full curing for preventing bleeding of dots or controlling the dot diameter. In general, the degree of polymerization for polymerizable compounds in preliminary curing is lower than the degree of polymerization for the polymerizable compounds in full curing to be performed after the preliminary curing. Moreover, the term “full curing” herein means curing of dots formed on a recording medium into a cured state that is required for the use of a recorded article. When the term “curing” is referred to in the specification, the above-described full curing is meant unless otherwise stated.

Exemplary recording media include, but are not particularly limited to, plastics, such as polyvinyl chloride, polyethylene terephthalate, polypropylene, polyethylene, and polycarbonates; surface-processed these plastics; glass; and coated paper.

### 1.5.1. Color Ink Attaching Step

In the above-described color ink attaching step, a color ink is discharged and allowed to impact a recording medium, thereby forming a coating film of the color ink on the recording medium.

The weight of the color ink droplet is not particularly limited, but is preferably 1 ng or more and 20 ng or less. The resolution of the color ink is not particularly limited, but is preferably 720 dpi×720 dpi or more and 1440 dpi×1440 dpi or less.

Moreover, the film thickness of the color ink when applied to (printed on) a recording medium is preferably 5 μm or more and 10 μm or less since good curing properties are achieved.

### 1.5.2. Color Ink Curing Step

In the color ink curing step, the coating film of the color ink that has been formed in the color ink attaching step is preliminarily cured. This color ink curing step is performed by a light source for color ink curing in an ink jet recording apparatus, for example.

In the color ink curing step, an LED having a peak wavelength of 350 nm or more and 410 nm or less is preferably used as an irradiation source for color ink curing. By controlling the amount of input current, irradiation energy is readily changeable in such an LED.

In the color ink curing step, the lower limit of irradiation intensity during curing upon irradiation is preferably 100 mW/cm² or more, more preferably 200 mW/cm² or more, and further preferably 300 mW/cm² or more. Meanwhile, the upper limit of irradiation intensity is preferably 1,900 mW/cm² or less, more preferably 1,700 mW/cm² or less, and further preferably 1,500 mW/cm² or less. When the irradiation intensity falls within the above-mentioned ranges, curing properties are enhanced.

The irradiation energy can be obtained by multiplying irradiation intensity from a light source for color ink curing by irradiation duration. For irradiation, the irradiation energy is preferably adjusted by adjusting irradiation duration while maintaining constant irradiation intensity at an irradiation unit. The irradiation duration can be adjusted by adjusting a scanning rate or an irradiation area during scanning relative to a recording medium at the irradiation unit.

The lower limit of irradiation energy during curing under irradiation by a light source for color ink curing is preferably 100 mJ/cm² or more, more preferably 200 mJ/cm² or more, and further preferably 300 mJ/cm² or more. Meanwhile, the upper limit of irradiation energy is preferably 1,000 mJ/cm² or less, more preferably 800 mJ/cm² or less, and further preferably 700 mJ/cm² or less. When the irradiation energy falls within the above-mentioned ranges, curing properties are enhanced.

In the present embodiment, the color ink curing step is preferably performed within 1 second and preferably within 0.1 second after completion of the color ink attaching step.

### 1.5.3. Clear Ink Attaching Step

The clear ink attaching step is a step of forming a coating film of the clear ink on the recording medium as well as part of or the entire coating film of the color ink by discharging the clear ink and allowing to impact the recording medium while partially or entirely overlapping the coating film of the color ink. In other words, when the coating film of the clear ink is formed on part of or the entire coating film of the color ink, the color ink and the clear ink, which constitute a radiation-curable ink jet ink set, can form almost overlapped images.

In the clear ink attaching step, the film thickness of the clear ink when applied to (printed on) a recording medium is preferably 3 μm or more and 15 μm or less since good curing properties are achieved.

### 1.5.4. Clear Ink Curing Step

In the clear ink curing step, the coating film of the clear ink is preliminarily cured under irradiation by a light source for preliminary curing. Before irradiation at irradiation energy of a light source for full curing in the full curing step described hereinafter, the clear ink is preferably irradiated by the light source for preliminary curing in the clear ink curing step. As a result, mixing (bleeding) of the color ink and the clear ink can be suppressed.

In the clear ink curing step, an irradiation source for clear ink curing is the same as the above-described irradiation source for color ink curing and may be an LED having a peak wavelength of 350 nm or more and 410 nm or less.

The lower limit of irradiation intensity during curing under irradiation by the light source for clear ink curing is preferably 100 mW/cm² or more, more preferably 200 mW/cm² or more, and further preferably 300 mW/cm² or more. Meanwhile, the upper limit of irradiation intensity is preferably 1,900 mW/cm² or less, more preferably 1,700 mW/cm² or less, and further preferably 1,500 mW/cm² or less. When the irradiation intensity falls within the above-mentioned ranges, curing properties are enhanced.

The lower limit of irradiation energy during curing under irradiation by the light source for clear ink curing is preferably 100 mJ/cm² or more, more preferably 200 mJ/cm² or more, and further preferably 300 mJ/cm² or more. Meanwhile, the upper limit of irradiation energy is preferably 1,000 mJ/cm² or less, more preferably 800 mJ/cm² or less, and further preferably 700 mJ/cm² or less. When the irradiation energy falls within the above-mentioned ranges, curing properties are enhanced.

In the present embodiment, the clear ink curing step is preferably performed within 1 second and preferably within 0.1 second after completion of the clear ink attaching step.

### 1.5.5. Full Curing Step

In the present embodiment, an image is preferably formed by curing the above-described preliminarily cured color ink coating film and clear ink coating film under irradiation by a light source for full curing. The full curing step is performed by a light source for full curing in an ink jet recording apparatus. An LED having a peak wavelength of 350 nm or more and 410 nm or less, for example, may be used as the irradiation source for full curing.

The lower limit of irradiation intensity during curing under irradiation by the light source for full curing is preferably 100 mW/cm² or more, more preferably 200 mW/cm² or more, and further preferably 300 mW/cm² or more. Meanwhile, the upper limit of irradiation intensity is preferably 1,900 mW/cm² or less, more preferably 1,700 mW/cm² or less, and further preferably 1,500 mW/cm² or less. When the irradiation intensity falls within the above-mentioned ranges, the curing properties of inks are enhanced.

The lower limit of irradiation energy in the full curing step, in other words, irradiation energy during curing of the above-described coating films formed from the radiation-curable ink jet ink set under irradiation by the light source for full curing is preferably 100 mJ/cm² or more, more preferably 200 mJ/cm² or more, and further preferably 300 mJ/cm² or more. Meanwhile, the upper limit of irradiation energy is preferably 1,000 mJ/cm² or less, more preferably 800 mJ/cm² or less, and further preferably 700 mJ/cm² or less. When the irradiation energy falls within the above-mentioned ranges, the curing properties of inks are enhanced.

### 1.6. Recorded Articles

A recorded article obtained by using the radiation-curable ink jet ink set and the ink jet recording method according to the present embodiment has an odor index of less than 10 calculated for the recorded article obtained after the clear ink curing step by a three sample-comparison odor bag method. Herein, the three sample-comparison odor bag method is a method based on the environmental sample testing method described in the olfactory measurement method manual published by the Japan Association on Odor Environment. According to the odor index, the recorded article obtained by using the radiation-curable ink jet ink set and the ink jet recording method of the present embodiment exhibits low odor and excellent curing ability.

### 1.7. Advantageous Effects

According to the radiation-curable ink jet ink set and the ink jet recording method of the present embodiment, it is possible to ensure curing properties of a recorded article by incorporating an intramolecular cleavage-type photoinitiator into the color ink composition. In addition, the color ink composition, due to a colorant contained therein, absorbs radiation but does not experience insufficient curing due to the intramolecular cleavage-type photoinitiator used in the color ink composition. Moreover, by covering with the clear ink, decomposition products of the intramolecular cleavage-type photoinitiator are blocked by a cured film of the clear ink. Consequently, odor problem does not arise. Meanwhile, the clear ink composition per se has low odor since a hydrogen abstraction-type photoinitiator is used. Although curing ability of a hydrogen abstraction-type photoinitiator is inferior to that of an intramolecular cleavage-type photoinitiator, no problem arises since a cured film obtained from the clear ink does not contain any colorant. Therefore, according to the radiation-curable ink jet ink set and the ink jet recording method of the present embodiment, it is possible to provide a radiation-curable ink jet ink set and an ink jet recording method that can obtain recorded articles having low odor and excellent curing ability.

### 2. Examples

Hereinafter, the present disclosure will be further specifically described by means of Examples and Comparative Examples. The present disclosure, however, is not solely limited to these Examples. Here, the units “part” and “%” in the Examples and Comparative Examples are based on mass unless otherwise indicated.

### 2.1. Preparation of Inks

Clear inks 1 to 3 and color inks 1 to 5 were obtained by feeding the respective materials to a mixing tank, which is a stainless steel vessel, to satisfy the ink composition shown in Tables 1 and 2, mixing and stirring to dissolve these materials, and filtering through a 5 membrane filter. In Table 2, each pigment was added as a dispersion prepared in advance by adding 50% by mass of a dispersant to the pigment. The numerical values of the respective components shown in Tables 1 and 2 are represented in % by mass.

TABLE 1

| Component | | Clear 1 | Clear 2 | Clear 3 |
|---|---|---|---|---|
| Hydroxy group-contain- | 4-HBA | 30.0 | 30.0 | — |
| ing monomer | DA-141 | 10.0 | 10.0 | — |
| Polymerizable compound | VEEA | 20.0 | 20.0 | 30.0 |
| | PEA | 20.0 | 20.0 | 30.0 |
| | SR 508 | 12.4 | 12.4 | 32.4 |
| photoinitiator | SpeedCure MBP | 5.0 | — | 5.0 |
| | SpeedCure DETX | 2.0 | 2.0 | 2.0 |
| | Irgacure 819 | — | 5.0 | — |
| Polymerization inhibitor | MEHQ | 0.1 | 0.1 | 0.1 |
| Surfactant | BYK-UV 3500 | 0.5 | 0.5 | 0.5 |

| | | | |
|---|---|---|---|
| Total | 100.0 | 100.0 | 100.0 |
| Clear ink curing properties | A | A | B |

TABLE 2

| | | Color 1 | Color 2 | Color 3 | Color 4 | Color 5 |
|---|---|---|---|---|---|---|
| Polymer- | PEA | 25.0 | 25.0 | 25.0 | 25.0 | 25.0 |
| izable | VEEA | 43.2 | 48.7 | 43.2 | 48.7 | 33.7 |
| compound | SR 508 | 15.0 | 12.0 | 15.0 | 12.0 | 12.0 |
| | DPHA | 5.0 | — | 5.0 | — | — |
| Surfactant | BYK-UV | 0.2 | 0.2 | 0.2 | 0.2 | 0.2 |
| | 3500 | | | | | |
| Polymer- | MEHQ | 0.1 | 0.1 | 0.1 | 0.1 | 0.1 |
| ization | | | | | | |
| inhibitor | | | | | | |
| photo- | Irgacure 819 | 5.0 | 5.0 | 5.0 | 5.0 | 5.0 |
| initiator | SpeedCure | 4.0 | 4.0 | 4.0 | 4.0 | 4.0 |
| | TPO | | | | | |
| Dispersant | Solsperse | 0.5 | 1.0 | 0.5 | 1.0 | 5.0 |
| | 36000 | | | | | |
| Pigment | Carbon black | 2.0 | — | — | — | — |
| | PR 122 | — | 4.0 | — | — | — |
| | PB 15:3 | — | — | 2.0 | — | — |
| | PY 155 | — | — | — | 4.0 | — |
| | Titanium | — | — | — | — | 15.0 |
| | oxide | | | | | |

| | | | | | |
|---|---|---|---|---|---|
| Total | 100.0 | 100.0 | 100.0 | 100.0 | 100.0 |

The components represented by abbreviations in the Tables are as follows.

### Monomers

4-HBA (trade name “4-HBA” from Osaka Organic Chemical Industry Ltd., 4-hydroxybutyl acrylate)

DA-141 (trade name from Nagase ChemteX Corporation, 2-hydroxy-3-phenoxypropyl acrylate)

VEER (trade name from Nippon Shokubai Co., Ltd., 2-[2-(vinyloxy) ethoxy]ethyl acrylate)

PEA (trade name “Viscoat #192” from Osaka Organic Chemical Industry Ltd., phenoxyethyl acrylate)

SR 508 (trade name from Sartomer Japan, dipropylene glycol diacrylate)

DPHA (from Shin-Nakamura Chemical Co., Ltd., dipentaerythritol hexaacrylate)

### Photoinitiators

SpeedCure MBP (trade name from DKSH Japan, 4-methylbenzophenone)

SpeedCure DETX (trade name from DKSH Japan, 2,4-diethylthioxanthen-9-one)

Irgacure 819 (trade name from BASF Japan Ltd., bis(2,4,6-trimethylbenzoyl)phenylphosphine oxide)

SpeedCure TPO (trade name from DKSH Japan, (2,4,6-trimethylbenzoyl)diphenylphosphine oxide)

### Polymerization Inhibitor

MEHQ (trade name “p-methoxyphenol” from Kanto Chemical Co., Inc., hydroquinone monomethyl ether)

### Surfactant

BYK-UV 3500 (trade name from BYK Japan KK, acrylic group-containing polyether-modified polydimethylsiloxane)

### Dispersant

Solsperse 36000 (trade name from Lubrizol Japan Limited) Pigments

Carbon black (black pigment)

PR 122 (C.I. Pigment Red 122, magenta pigment)

PB 15:3 (C.I. Pigment Blue 15:3, cyan pigment)

PY 155 (C.I. Pigment Yellow 155, yellow pigment)

Titanium oxide (white pigment)

### 2.2. Evaluation of Clear Inks

The curing properties of a clear ink were evaluated by printing a solid pattern of the clear ink at a resolution of 720 dpi×720 dpi and an ink weight of 14 ng/dot on a PET film (trade name “PET50A PL Shin” from Lintec Corporation) by using a printer for evaluation “Ink Jet Printer PX-G 5000 (from Seiko Epson Corporation)”; irradiating with 395 nm-wavelength UV at an irradiation intensity of 1,000 mW/cm²; and calculating UV irradiation energy [mJ/cm²] needed for ink curing. The irradiation energy [mJ/cm²] was obtained by measuring irradiation intensity [mW/cm²] at a surface irradiated with UV from a light source; and multiplying the irradiation intensity by irradiation duration [s]. The irradiation intensity was measured by using a UV meter UM-10 and a light receiver UM-400 (both from Konica Minolta Sensing, Inc.). The evaluation criteria are as follows, and the obtained evaluation results are shown in Table 1.

### Evaluation Criteria

A: less than 500 mJ/cm²

B: 500 mJ/cm² or more

### 2.3. Evaluation as Ink Sets

### 2.3.1. Production of Printed Articles

Each ink set consisting of a clear ink and the color inks was prepared in the combination shown in Table 3 and subjected to an evaluation test. Specifically, a PET film (trade name “Cosmoshine A 4300” from Toyobo Co. Ltd., thickness of 100 μm) was printed with the color inks at a printing rate of 15 m/min by using an ink jet printer SurePress L-6034VW (trade name from Seiko Epson Corporation) and irradiated with 395 nm-wavelength UV at an energy of 300 mJ/cm². Subsequently, a solid pattern was printed with the clear ink over the image printed by the color inks and irradiated with 395 nm-wavelength UV at an energy of 600 mJ/cm², thereby producing a printed article.

### 2.3.2. Evaluation Method

Within 30 minutes after production, the obtained printed article was cut into a size of 300 mm×1,000 mm and spread, and the air at a 100 mm-height position from the printed surface was collected by a handy pump. The odor index was calculated through a test by a three sample-comparison odor bag method based on the environmental sample testing method described in the olfactory measurement method manual published by the Japan Association on Odor Environment. The evaluation criteria are as follows, and the obtained evaluation results are shown in Table 3.

### Evaluation Criteria

A: Odor index of a printed article of less than 10

B: Odor index of a printed article of 10 or more

TABLE 3

| | | Comp. | Comp. | Comp. |
|---|---|---|---|---|
| | Ex. 1 | Ex. 1 | Ex. 2 | Ex. 3 |
| Clear ink | Clear 1 | Clear 2 | Clear 3 | — |
| Clear printing after color | Present | Present | Present | Absent |
| printing | | | | |
| Odor index of printed | A | B | A | B |
| article | | | | |

### 2.3.3. Evaluation Results

As shown in Table 3, Example 1 in which the clear ink contains a hydrogen abstraction-type photoinitiator and hydroxy group-containing monomers whereas the color inks each contain intramolecular cleavage-type photoinitiators and a colorant had odor index of the printed article of less than 10 and no concern about curing properties of the clear ink as shown in Table 1. As described above, Example 1 achieved low odor and excellent curing ability by covering with the clear ink after color ink printing.

In contrast, Comparative Example 1 in which the clear ink does not contain any hydrogen abstraction-type photoinitiator had a high odor index of the printed article. Moreover, Comparative Example 2 in which the clear ink does not contain any hydroxy group-containing monomer had a low odor index of the printed article but inferior curing properties of the clear ink as shown in Table 1. Further, Comparative Example 3 without clear ink printing after color printing had a high odor index of the printed article.

The present disclosure is not limited to the above-described embodiments, and various modifications are possible. For example, the present disclosure encompasses the constitution substantially the same as the constitution described as the embodiment (the constitution with the same function, method, and results or the constitution with the same object and effects, for example). In addition, the present disclosure encompasses the constitution that is described as the embodiment but is replaced in the nonessential portion. Moreover, the present disclosure encompasses the constitution that exerts the same advantageous effects as the constitution described as the embodiment or the constitution that can attain the same object as the constitution described as the embodiment. Further, the present disclosure encompasses the constitution in which the constitution described as the embodiment is added with a well-known technique.

What is claimed is:

1. A radiation-curable ink jet ink set comprising:
a radiation-curable clear ink composition; and
a radiation-curable color ink composition, wherein:
the clear ink composition contains a hydrogen abstraction-type photoinitiator and a hydroxy group-containing monomer; and
the color ink composition contains an intramolecular cleavage-type photoinitiator and a colorant.

2. The radiation-curable ink jet ink set according to claim 1, wherein the hydrogen abstraction-type photoinitiator is a benzophenone-type photoinitiator or a thioxanthone-type photoinitiator.

3. The radiation-curable ink jet ink set according to claim 1, wherein the hydroxy group-containing monomer is 4-hydroxybutyl acrylate or 2-hydroxy-3-phenoxypropyl acrylate.

4. The radiation-curable ink jet ink set according to claim 1, wherein the intramolecular cleavage-type photoinitiator is an acylphosphine oxide photoinitiator.

5. An ink jet recording method comprising:
a color ink attaching step of attaching a radiation-curable color ink composition containing an intramolecular cleavage-type photoinitiator and a colorant to a recording medium by discharging the color ink composition from an ink jet head;
a color ink curing step of curing the color ink composition attached to the recording medium;
a clear ink attaching step of attaching a radiation-curable clear ink composition containing a hydrogen abstraction-type photoinitiator and a hydroxy group-containing monomer to the recording medium so as to partially or entirely overlap a region where the color ink composition is attached to; and
a clear ink curing step of curing the clear ink composition.

6. A recorded article that is recorded by the ink jet recording method according to claim 5, wherein an odor index is less than 10 calculated for the recorded article after the clear ink curing step by a three sample-comparison odor bag method.
